(19) United States
(12) Patent Application Publication
(10) Pub. No.: US 2026/0216804 A1
(43) Pub. Date: Jul. 30, 2026

(54) ELECTROCHEMICAL MACHINING TOOL, ELECTROCHEMICAL MACHINING DEVICE, AND BLADE MANUFACTURING METHOD

(71) Applicants: MITSUBISHI HEAVY INDUSTRIES, LTD., Tokyo (JP); Mitsubishi Power, Ltd., Tokyo (JP)

(72) Inventors: Yosuke MUKAI, Tokyo (JP); Yuki ASAI, Tokyo (JP); Takaaki ODA, Tokyo (JP); Sunao TAKAI, Tokyo (JP)

(21) Appl. No.: 19/142,467

(22) PCT Filed: Dec. 12, 2023
(86) PCT No.: PCT/JP2023/044391

§ 371 Date: Jun. 23, 2025

(30) Foreign Application Priority Data
Dec. 28, 2022 (JP) 2022-211124

(51) Int. Cl. B23H 9/10

(52) U.S. Cl. CPC B23H 9/10

(57) ABSTRACT

The present invention has: a tool electrode that is cylindrical around the tool axis and that forms an electrolytic solution passage on the inner circumferential side thereof; and an insulating layer that is formed on the outer circumferential surface of the cylindrical tool electrode. The electrolytic solution passage has: an outlet that is formed at the end on a first side, among the first side and a second side in the axis direction in which the tool axis extends, within the tool electrode; and a diameter expansion portion in which the inner diameter thereof increases gradually toward the first side. The end on the first side in the diameter expansion portion is said outlet.

### TECHNICAL FIELD

The present invention relates to an electrolysis machining tool, an electrolysis machining device provided with the electrolysis machining tool, and a blade manufacturing method using the device.

Priority is claimed on Japanese Patent Application No. 2022-211124 filed on Dec. 28, 2022, the content of which is incorporated herein by reference.

### BACKGROUND ART

When a hole is formed in a difficult-to-cut material in which machining is difficult, an electrolysis machining method or a discharge machining method is likely to be adopted. In particular, when forming a hole having a high aspect ratio in a difficult-to-cut material, an electrolysis machining method is likely to be adopted.

In general, an electrolysis machining device for performing an electrolysis machining method includes an electrolysis machining tool, a movement mechanism that relatively moves the electrolysis machining tool with respect to a workpiece, a power supply circuit, and an electrolytic solution supply machine. The electrolysis machining tool includes a tool electrode and an insulation layer that covers a part of the tool electrode. The power supply circuit applies a voltage between the tool electrode and the workpiece such that the tool electrode is a negative electrode and the workpiece is a positive electrode.

The following PTL 1 discloses an electrolysis machining tool of an electrolysis machining device. This electrolysis machining tool has a tubular tool electrode around a tool axis and an insulation layer covering an outer peripheral surface of the tubular tool axis.

### CITATION LIST

### Patent Literature

[PTL 1] Japanese Patent No. 6071742

### SUMMARY OF INVENTION

### Technical Problem

In the case of electrolysis machining, it is desirable to increase the value of a current flowing between the tool electrode and the workpiece via the electrolytic solution while suppressing the voltage applied between the tool electrode and the workpiece as much as possible, and to improve the machining efficiency of the workpiece.

Therefore, an object of the present disclosure is to provide a technique capable of improving the machining efficiency of a workpiece.

### Solution to Problem

According to one aspect of the invention for achieving the above object, there is provided an electrolysis machining tool including: a tool electrode that is tubular around a tool axis and of which an inner peripheral side forms an electrolytic solution passage; and an insulation layer that is formed on an electrode outer peripheral surface, which is an outer peripheral surface of the tubular tool electrode. The electrolytic solution passage includes an outlet formed at an end on a first side among the first side and a second side in an axial direction in which the tool axis extends in the tool electrode, and a diameter increasing portion in which an inner diameter gradually increases toward the first side. An end on the first side of the diameter increasing portion is the outlet.

During the electrolysis machining, hydrogen ions or water contained in the electrolytic solution receive electrons from the tool electrode used as a cathode to form hydrogen bubbles. The electrolytic solution passage according to the present aspect has a diameter increasing portion whose inner diameter gradually increases toward the first side, and an end on the first side in the diameter increasing portion is an outlet of the electrolytic solution passage. For this reason, in the present aspect, on the first side of the tool electrode, a vortex flow of the electrolytic solution is not easily formed, and a plurality of bubbles smoothly flow, and thus it is possible to suppress the retention of the plurality of bubbles between the tool electrode and the workpiece. Therefore, in the present aspect, it is possible to suppress an increase in electric resistance between the tool electrode and the workpiece, and when the voltage applied between the tool electrode and the workpiece is increased, the value of the current flowing between the tool electrode and the workpiece also increases with an increase in the voltage, and thus it is possible to improve the machining efficiency.

According to one aspect of the invention for achieving the above object, there is provided an electrolysis machining device including: the electrolysis machining tool; a power supply circuit configured to apply a voltage between the tool electrode and a workpiece such that the tool electrode of the electrolysis machining tool is a negative electrode and the workpiece to be machined by the electrolysis machining tool is a positive electrode; a movement mechanism configured to relatively move the electrolysis machining tool with respect to the workpiece; an electrolytic solution supply machine configured to supply an electrolytic solution to the electrolytic solution passage; and a controller configured to control the power supply circuit, the movement mechanism, and the electrolytic solution supply machine.

Since the electrolysis machining device according to the present aspect includes the electrolysis machining tool described above, it is possible to suppress the retention of the plurality of bubbles between the tool electrode and the workpiece, and it is possible to improve the machining efficiency of the workpiece.

According to one aspect of the invention for achieving the above object, there is provided a blade manufacturing method executing: an intermediate product forming step of forming a blade intermediate product in which an outer surface of a target shape is formed; a cooling passage forming step of forming a cooling passage inside the blade intermediate product; and a finishing step of performing a finishing treatment on the blade intermediate product in which the cooling passage is formed. In the cooling passage forming step, the cooling passage is formed in the blade intermediate product by using the electrolysis machining device.

In the blade manufacturing method according to the present aspect, the cooling passage is formed in the blade intermediate product by using the electrolysis machining device. Therefore, the machining efficiency of the blade intermediate product is improved, and the manufacturing cost of the blade can be reduced.

### Advantageous Effects of Invention

According to one aspect of the present disclosure, it is possible to improve the machining efficiency of a workpiece.

### BRIEF DESCRIPTION OF DRAWINGS

FIG. 1 is a schematic diagram showing a configuration of an electrolysis machining device in an embodiment according to the present disclosure.

FIG. 2 is a sectional view of a main part of an electrolysis machining tool in the embodiment according to the present disclosure,

FIG. 3 is a sectional view of a main part of an electrolysis machining tool in a comparative example.

FIG. 4 is a sectional view of a main part of an electrolysis machining tool in a first modification example of the embodiment according to the present disclosure.

FIG. 5 is a sectional view of a main part of an electrolysis machining tool in a second modification example of the embodiment according to the present disclosure.

FIG. 6 is a sectional view of a main part of an electrolysis machining tool in a third modification example of the embodiment according to the present disclosure.

FIG. 7 is a sectional view of a main part of an electrolysis machining tool in a fourth modification example of the embodiment according to the present disclosure.

FIG. 8 is a sectional view of a main part of an electrolysis machining tool in a fifth modification example of the embodiment according to the present disclosure.

FIG. 9 is a flowchart showing an execution procedure of a blade manufacturing method in the embodiment according to the present disclosure.

FIG. 10 is a sectional view of a blade intermediate product in the embodiment according to the present disclosure.

FIG. 11 is a sectional view of a blade intermediate product during a cooling passage forming step in the embodiment according to the present disclosure.

FIG. 12 is a sectional view of a blade in the embodiment according to the present disclosure.

FIG. 13 is a sectional view of a blade in a modification example of the embodiment according to the present disclosure.

### DESCRIPTION OF EMBODIMENTS

Hereinafter, various embodiments of the present invention and modification examples thereof will be described in detail with reference to the drawings.

### Embodiment of Electrolysis Machining Device

Hereinafter, an electrolysis machining device according to an embodiment of the present disclosure will be described with reference to Figs. I to 3.

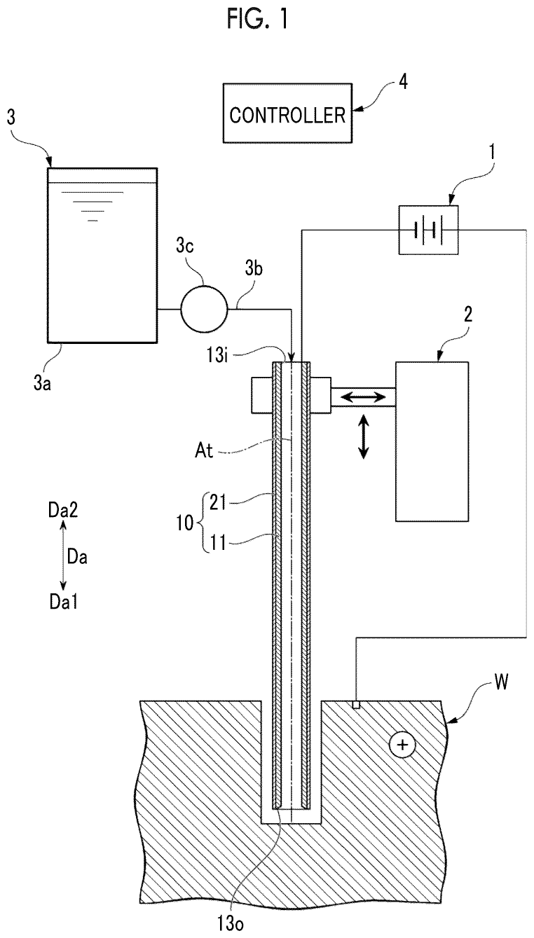

As shown in FIG. 1, the electrolysis machining device in the present embodiment includes an electrolysis machining tool 10, a power supply circuit 1, a movement mechanism 2, an electrolytic solution supply machine 3, and a controller 4.

The electrolysis machining tool 10 includes a tool electrode 11 that is tubular around a tool axis At and of which an inner peripheral side forms an electrolytic solution passage 13, and an insulation layer 21 that is formed on an outer peripheral surface of the tubular tool electrode 11. The power supply circuit 1 is a circuit capable of applying a voltage between the tool electrode 11 and a workpiece W such that the tool electrode 11 is a negative electrode and the workpiece W to be machined by the electrolysis machining tool 10 is a positive electrode. The movement mechanism 2 is a mechanism that relatively moves the electrolysis machining tool 10 with respect to the workpiece W. The movement mechanism 2 may be a mechanism that moves the electrolysis machining tool 10 or a mechanism that moves the workpiece W. The electrolytic solution supply machine 3 can supply an electrolytic solution to the electrolytic solution passage 13 of the electrolysis machining tool 10. The electrolytic solution supply machine 3 includes a tank 3a in which the electrolytic solution is stored, an electrolytic solution line 3b that connects the tank 3a and the electrolytic solution passage 13 of the electrolysis machining tool 10, and a pump 3c that is provided in the electrolytic solution line 3b. The electrolytic solution in the present embodiment is, for example, a nitric acid aqueous solution. In addition, the electrolytic solution includes a neutral solution such as a NaCl solution or a NaNO3 solution, an acidic solution such as a sulfuric acid aqueous solution, and the like. The controller 4 can control the operations of the power supply circuit 1, the movement mechanism 2, and the electrolytic solution supply machine 3.

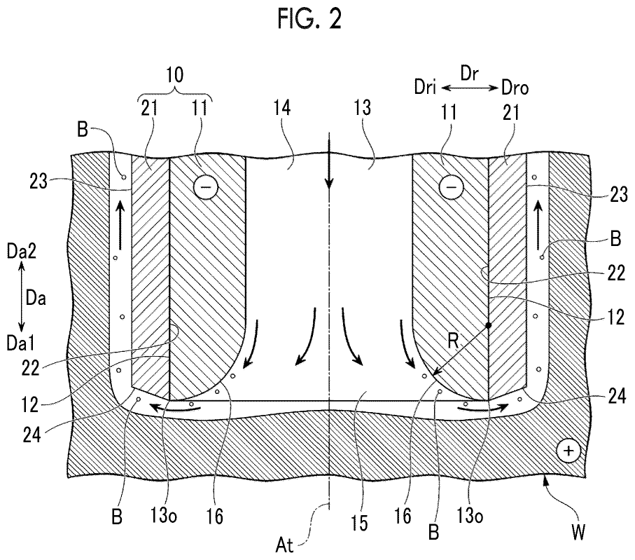

Here, as shown in FIG. 2, a direction in which the tool axis At extends is referred to as an axial direction Da, one side in the axial direction Da is referred to as a first side Dal, and the other side in the axial direction Da is referred to as a second side Da2. In addition, a direction perpendicular to the tool axis At is a radial direction Dr, a side away from the tool axis At in the radial direction Dr is a radial outer side Dro, and a side close to the tool axis At in the radial direction Dr is a radial inner side Dri.

The tool electrode 11 is formed of a metal having conductivity, such as stainless steel, pure Ti, and a Ti alloy. The electrolytic solution passage 13 formed in the tool electrode 11 extends in the axial direction Da around the tool axis At. The electrolytic solution passage 13 has an inlet 13i (refer to FIG. 1), an outlet 13o, a main passage portion 14, and a diameter increasing portion 15. The inlet 13i of the electrolytic solution passage 13 is formed at an end of the tool electrode 11 on the second side Da2. The outlet 13o of the electrolytic solution passage 13 is formed at the end of the tool electrode 11 on the radial outer side Dro, that is, at the end of the tool electrode 11 on the first side Da1. The electrolytic solution supplied from the electrolytic solution supply machine 3 flows into the electrolytic solution passage 13 from the inlet 13i and flows out from the outlet 13o. The main passage portion 14 is a portion having a constant inner diameter in the electrolytic solution passage 13 at any position in the axial direction Da. An end on the second side Da2 of the main passage portion 14 is located at a position of an end on the second side Da2 of the tool electrode 11 to form the inlet 13i. The diameter increasing portion 15 is a portion in which the inner diameter of the electrolytic solution passage 13 gradually increases toward the first side Dal in the electrolytic solution passage 13. An end of the diameter increasing portion 15 on the second side Da2 is connected to an end of the main passage portion 14 on the first side Da1. In addition, an end of the diameter increasing portion 15 on the first side Dal is the outlet 13o of the electrolytic solution passage 13. In other words, the end on the first side Dal of the diameter increasing portion 15 is the end of the tool electrode 11 on the radial outer side Dro, and coincides with the position of the end of the tool electrode 11 on the first side Da1.

An inner peripheral surface 16 of the tool electrode 11 defining the diameter increasing portion 15 of the electrolytic solution passage 13 has a shape along a curved line having a radius of curvature R with a position on the radial outer side Dro with respect to the inner peripheral surface 16 and on the second side Da 2 with respect to the outlet 13o as a curvature center. For this reason, the inner peripheral surface 16 is a curved surface corresponding to the shape of the inner peripheral surface of a horn. Therefore, the inner peripheral surface 16 is a smoothly continuous curved surface, and the entire inner peripheral surface 16 is a convex curved surface on a side close to the tool axis At.

The insulation layer 21 is formed on an electrode outer peripheral surface 12, which is an outer peripheral surface of the tubular tool electrode 11. The insulation layer 21 has an insulation layer inner peripheral surface 22, an insulation layer outer peripheral surface 23, and a first side insulation layer end surface 24. The insulation layer inner peripheral surface 22 is an inner peripheral surface of the insulation layer 21, and is in contact with the electrode outer peripheral surface 12. The insulation layer outer peripheral surface 23 is an outer peripheral surface of the insulation layer 21. The first side insulation layer end surface 24 is a surface that connects the end on the first side Da1 of the insulation layer inner peripheral surface 22 and the end on the first side Da1 of the insulation layer outer peripheral surface 23. For this reason, the first side insulation layer end surface 24 extends from the end of the electrode outer peripheral surface 12 on the first side Da1 to the end of the insulation layer outer peripheral surface 23 on the first side Da1 toward the radial outer side Dro. The first side insulation layer end surface 24 gradually extends toward the second side Da2 as the first side insulation layer end surface 24 is directed toward the radial outer side Dro. However, the first side insulation layer end surface 24 in a cross section of the tool electrode 11 including the tool axis At has a linear shape. In the present embodiment, in the axial direction Da, the position of the end of the insulation layer inner peripheral surface 22 on the first side Dal coincides with the position of the end of the electrode outer peripheral surface 12 on the first side Da1.

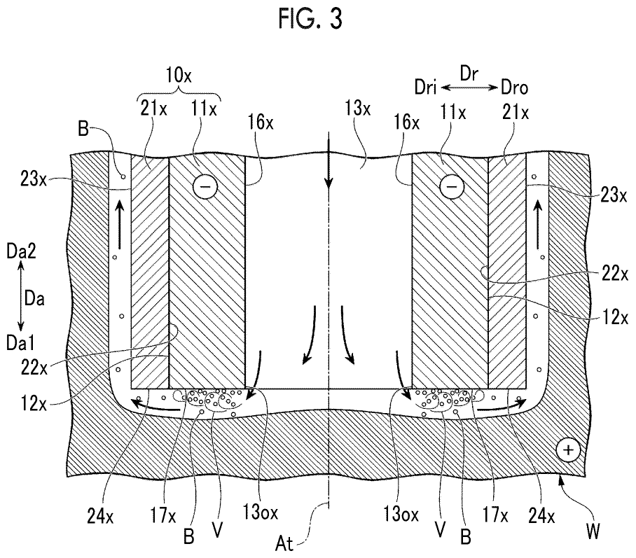

In the case of the electrolysis machining, it is desirable to increase the value of a current flowing between the tool electrode 11 and the workpiece W via the electrolytic solution while suppressing the voltage applied between the tool electrode 11 and the workpiece W as much as possible to improve the machining efficiency. Therefore, the inventor analyzed the flow of the electrolytic solution when an electrolysis machining tool 10x of the comparative example shown in FIG. 3 is used.

As in the electrolysis machining tool 10 in the present embodiment, the electrolysis machining tool 10x in the comparative example also has a tool electrode 11x that is tubular around the tool axis At and of which an inner peripheral side forms an electrolytic solution passage 13x, and an insulation layer 21x that is formed on an electrode outer peripheral surface 12x, which is the outer peripheral surface of the tubular tool electrode 11x.

The electrolytic solution passage 13x formed in the tool electrode 11x extends in the axial direction Da around the tool axis At. The inner diameter of the electrolytic solution passage 13x in the comparative example is a constant inner diameter at any position in the axial direction Da. Therefore, the electrolytic solution passage 13x in the comparative example does not have a portion corresponding to the diameter increasing portion 15 of the electrolytic solution passage 13 in the present embodiment. An outlet 13ox is formed at a position of an end of the tool electrode 11x on the first side Dal and an end of the tool electrode 11x on the radial inner side Dri. Therefore, the outlet 13ox of the comparative example is not formed at the position of the end on the radial outer side Dro of the tool electrode 11x, as in the outlet 13o of the present embodiment.

An end of an inner peripheral surface 16x on the first side Dal of the tool electrode 11x in the comparative example and an end of the electrode outer peripheral surface 12x on the first side Dal of the tool electrode 11x are connected by a first side electrode end surface 17x facing the first side Da1. An end on the first side Da1 of an insulation layer outer peripheral surface 23x and an end on the first side Da1 of an insulation layer inner peripheral surface 22x are connected by a first side insulation layer end surface 24x. Both the first side electrode end surface 17x and the first side insulation layer end surface 24x are surfaces perpendicular to the tool axis At. In addition, the first side insulation layer end surface 24x is flush with the first side electrode end surface 17x.

As a result of analyzing the flow of the electrolytic solution when the electrolysis machining tool 10x of the comparative example is used, the inventor has found that a plurality of vortex flows V of the electrolytic solution are formed along the first side electrode end surface 17x and in the region of the first side electrode end surface 17x on the first side Da1. This is considered to be because, when the electrolytic solution flows out from the outlet 13o of the electrolytic solution passage 13, a flow path through which the electrolytic solution flows rapidly extends to the radial outer side Dro.

During the electrolysis machining, hydrogen ions or water contained in the electrolytic solution receive electrons from the tool electrodes 11, 11x serving as cathodes to form hydrogen bubbles B.

As described above, in the comparative example, the plurality of vortex flows V are formed along the first side electrode end surface 17x and in the region on the first side Da1 of the first side electrode end surface 17x. For this reason, a plurality of bubbles B stay in the plurality of vortex flows V. When the plurality of bubbles B stay between the tool electrode 11x and the workpiece W, electric resistance between the tool electrode 11x and the workpiece W increases. Therefore, in the comparative example, even when the voltage applied between the tool electrode 11x and the workpiece W is increased, the value of the current flowing between the tool electrode 11x and the workpiece W does not increase in proportion to the change in the voltage, and the machining efficiency of the workpiece W is not very good.

As described above, the electrolytic solution passage 13 of the present embodiment includes the diameter increasing portion 15 in which the inner diameter gradually increases toward the first side Da1. Moreover, the inner peripheral surface 16 of the tool electrode 11 defining the diameter increasing portion 15 is a smoothly continuous curved surface corresponding to the inner peripheral surface of the horn, and the entire inner peripheral surface 16 is a convex curved surface on the side close to the tool axis At. For this reason, in the present embodiment, the vortex flow V of the electrolytic solution is not substantially formed on the first side Da1 of the tool electrode 11, and the plurality of bubbles B smoothly flow, and thus it is possible to suppress the retention of the plurality of bubbles B between the tool electrode 11 and the workpiece W. Therefore, in the present embodiment, it is possible to suppress an increase in electric resistance between the tool electrode 11 and the workpiece W, and when the voltage applied between the tool electrode 11 and the workpiece W is increased, the value of the current flowing between the tool electrode 11 and the workpiece W also increases with an increase in the voltage, and thus the machining efficiency of the workpiece W can be improved.

In addition, since the first side insulation layer end surface 24 in the present embodiment gradually extends toward the second side Da2 as the first side insulation layer end surface 24 is directed toward the radial outer side Dro, the bubbles B in the electrolytic solution flowing along the inner peripheral surface 16 of the tool electrode 11 defining the diameter increasing portion 15 are likely to flow to the side of the insulation layer outer peripheral surface 23. For this reason, in the present embodiment, from this viewpoint as well, the plurality of bubbles B smoothly flow, and thus it is possible to suppress the retention of the plurality of bubbles B between the tool electrode 11 and the workpiece W.

### First Modification Example of Electrolysis Machining Tool

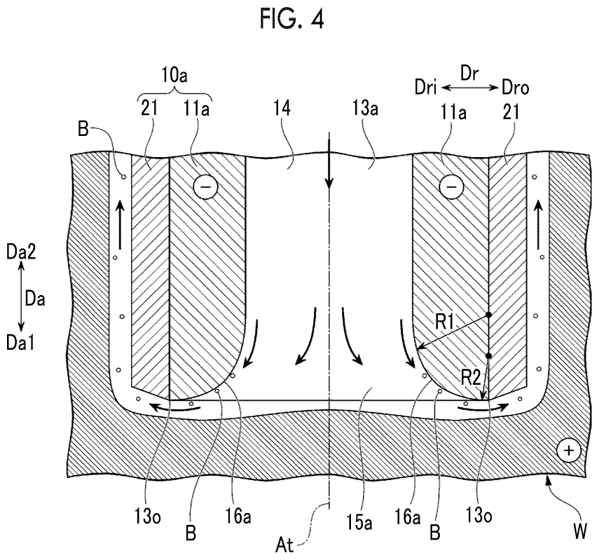

A first modification example of the electrolysis machining tool will be described with reference to FIG. 4.

As in the electrolysis machining tool 10 in the above-described embodiment, an electrolysis machining tool 10a in the present modification example also has a tool electrode 11a that is tubular around the tool axis At and of which an inner peripheral side forms an electrolytic solution passage 13a, and the insulation layer 21 that is formed on the electrode outer peripheral surface 12, which is the outer peripheral surface of the tubular tool electrode 11a.

As in the electrolytic solution passage 13 in the above-described embodiment, the electrolytic solution passage 13a in the present modification example also has the inlet, the outlet 13o, the main passage portion 14, and a diameter increasing portion 15a. However, the configuration of the diameter increasing portion 15a in the present modification example is different from the configuration of the diameter increasing portion 15 in the above-described embodiment.

The inner peripheral surface 16 of the tool electrode 11 defining the diameter increasing portion 15 in the above-described embodiment is a curved line defined by one radius of curvature R. On the other hand, the inner peripheral surface 16a of the tool electrode 11a defining the diameter increasing portion 15a in the present modification example is a curved surface defined by a plurality of radii of curvature R1, R2. The position of the curvature center with respect to the radius of curvature R1 and the position of the curvature center with respect to the radius of curvature R2 are both at a position on the radial outer side Dro with respect to the inner peripheral surface 16a of the tool electrode 11a defining the diameter increasing portion 15a and on the second side Da2 with respect to the outlet 13o. A curved surface defined by the radius of curvature R1 and a curved surface defined by the radius of curvature R2 are connected to the curved surface defined by the radius of curvature R1.

Therefore, as in the above-described embodiment, the inner peripheral surface 16a of the tool electrode 11a defining the diameter increasing portion 15a in the present modification example is also a curved surface corresponding to the shape of the inner peripheral surface of the horn. For this reason, the inner peripheral surface 16a is also a smoothly continuous curved surface, and the entire inner peripheral surface 16a is a convex curved surface on the side close to the tool axis At. Therefore, in the electrolysis machining tool 10a in the present modification example, as in the electrolysis machining tool 10 in the above-described embodiment, it is possible to suppress the retention of the plurality of bubbles B between the tool electrode 11a and the workpiece W and to suppress an increase in electric resistance between the tool electrode 11a and the workpiece W.

The inner peripheral surface 16a of the tool electrode 11a defining the diameter increasing portion 15a in the present modification example is a curved surface defined by the two radii of curvature R1, R2, but may be a curved surface defined by three or more radii of curvature. Further, the radius of curvature of the inner peripheral surface 16a may gradually change, as in an ellipse, according to a change in position in the axial direction Da.

### Second Modification Example of Electrolysis Machining Tool

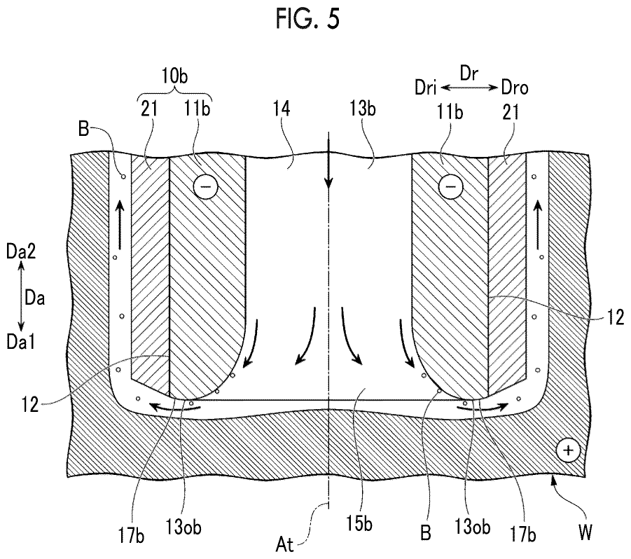

A second modification example of the electrolysis machining tool will be described with reference to FIG. 5.

As in the electrolysis machining tool 10 in the above-described embodiment, an electrolysis machining tool 10b in the present modification example also has a tool electrode 11b that is tubular around the tool axis At and of which an inner peripheral side forms an electrolytic solution passage 13b, and the insulation layer 21 that is formed on the electrode outer peripheral surface 12, which is the outer peripheral surface of the tubular tool electrode 11b.

As in the electrolytic solution passage 13 in the above-described embodiment, the electrolytic solution passage 13b in the present modification example also has the inlet, an outlet 13ob, the main passage portion 14, and a diameter increasing portion 15b. However, the position of the outlet 13ob in the present modification example is different from the position of the outlet 13o in the above-described embodiment.

The outlets 13o of the electrolytic solution passages 13, 13a in the above-described embodiment and the first modification example are formed at the ends on the radial outer side Dro of the tool electrodes 11, 11a, that is, at the ends on the first side Da1 of the tool electrodes 11, 11a. On the other hand, the outlet 13ob of the electrolytic solution passage 13b in the present modification example is formed at a position between the end on the radial outer side Dro and the end on the radial inner side Dri in the tool electrode 11b, that is, the end on the first side Da1 in the tool electrode 11b.

A first side electrode end surface 17b facing the first side Da1 is formed between the outlet 13ob of the electrolytic solution passage 13b and the electrode outer peripheral surface 12 of the tool electrode 11b, which are on the outer surface of the tool electrode 11b in the present modification example. The first side electrode end surface 17b is a surface that is formed to gradually face the second side Da2 toward the radial outer side Dro from the outlet 13ob of the electrolytic solution passage 13b, and is a convex curved surface toward the radial outer side Dro.

As in the above-described embodiment and each of the above-described modification examples, an inner peripheral surface 16b of the tool electrode 11b defining the diameter increasing portion 15b of the electrolytic solution passage 13b in the present modification example is a curved surface of which the inner diameter gradually and smoothly becomes closer to the radial outer side Dro toward the first side Da1. In addition, as in the above-described embodiment and each of the above-described modification examples, the end of the diameter increasing portion 15b on the first side Da1 in the present modification example is the end of the tool electrode 11b on the first side Da1, and is the outlet 13ob of the electrolytic solution passage 13b.

Therefore, also in the present modification example, as in the above-described embodiment and each of the above-described modification examples, the retention of the plurality of bubbles B between the tool electrode 11b and the workpiece W can be suppressed, and an increase in electric resistance between the tool electrode 11b and the workpiece W can be suppressed.

### Third Modification Example of Electrolysis Machining Tool

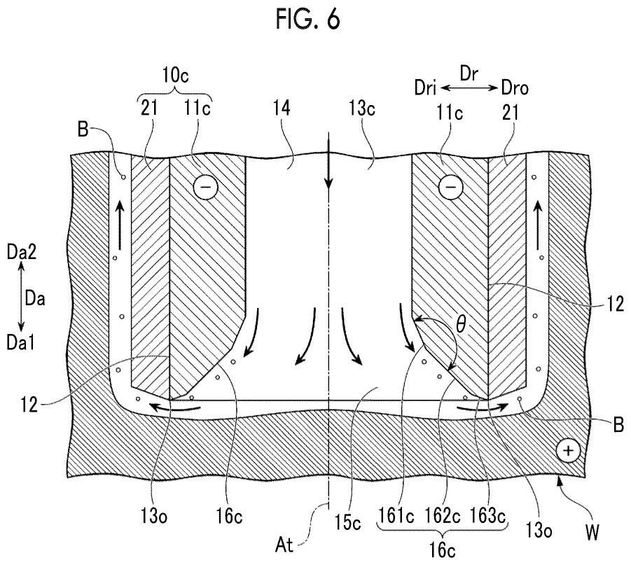

A third modification example of the electrolysis machining tool will be described with reference to FIG. 6.

As in the electrolysis machining tool 10 in the above-described embodiment, an electrolysis machining tool 10c in the present modification example also has a tool electrode 11c that is tubular around the tool axis At and of which an inner peripheral side forms an electrolytic solution passage 13c, and the insulation layer 21 that is formed on the electrode outer peripheral surface 12, which is the outer peripheral surface of the tubular tool electrode 11c.

As in the electrolytic solution passage 13 in the above-described embodiment, the electrolytic solution passage 13c in the present modification example also has the inlet, the outlet 13o, the main passage portion 14, and a diameter increasing portion 15c. However, the configuration of the diameter increasing portion 15c in the present modification example is different from the configuration of the diameter increasing portion 15 in the above-described embodiment.

An inner peripheral surface 16c of the tool electrode 11c defining the diameter increasing portion 15c in the present modification example has a first inner peripheral surface 161c, a second inner peripheral surface 162c, and a third inner peripheral surface 163c. All of the first inner peripheral surface 161c, the second inner peripheral surface 162c, and the third inner peripheral surface 163c have a surface shape corresponding to a part of an outer peripheral surface of a cone having the second side Da2 as a vertex and the first side Da1 as a bottom surface. The end of the first inner peripheral surface 161c on the second side Da2 is connected to the end of the main passage portion 14 on the first side Da1 in the electrolytic solution passage 13c. The end of the second inner peripheral surface 162c on the second side Da2 is connected to the end of the first inner peripheral surface 161c on the first side Da1. The end of the third inner peripheral surface 163c on the second side Da2 is connected to the end of the second inner peripheral surface 162c on the first side Da1. The end of the third inner peripheral surface 163c on the first side Da1 is the outlet 13o. For this reason, the shape of the inner peripheral surface 16c of the tool electrode 11c defining the diameter increasing portion 15c in the cross section of the tool electrode 11c including the tool axis At is a shape in which three straight lines are connected to each other.

Here, the displacement amount on the radial outer side Dro with respect to the unit displacement amount to the first side Da1 in each of the inner peripheral surfaces 161c, 162c, 163c is referred to as a diameter increasing rate. The diameter increasing rate of the second inner peripheral surface 162c is larger than the diameter increasing rate of the first inner peripheral surface 161c. In addition, the diameter increasing rate of the third inner peripheral surface 163c is larger than the diameter increasing rate of the second inner peripheral surface 162c.

Therefore, as in the diameter increasing portions 15, 15a, 15b in the above-described embodiment and each of the above-described modification examples, the inner diameter of the diameter increasing portion 15c in the present modification example also gradually increases toward the first side Da1. In addition, as in the inner peripheral surfaces 16, 16a, 16b of the tool electrodes 11, 11a, 11b defining the diameter increasing portions 15, 15a, 15b in the above-described embodiment and each of the above-described modification examples, the entire inner peripheral surface 16c of the tool electrode 11c defining the diameter increasing portion 15c in the present modification example is a convex surface on the side close to the tool axis At.

In addition, in a cross section of the tool electrode 11c including the tool axis At, an inner angle θ formed by the first inner peripheral surface 161c and the second inner peripheral surface 162c and an inner angle formed by the second inner peripheral surface 162c and the third inner peripheral surface 163c are both 150° or more and less than 180°.

As described above, in the inner peripheral surface 16c defining the diameter increasing portion 15c in the present modification example, unlike the above-described embodiment and each of the above-described modification examples, the shape of the inner peripheral surface 16c defining the diameter increasing portion 15c in the cross section of the tool electrode 11c including the tool axis At is a shape in which three straight lines are connected to each other. However, as in the diameter increasing portions 15, 15a, 15b in the above-described embodiment and each of the above-described modification examples, the inner diameter of the diameter increasing portion 15c in the present modification example gradually increases toward the first side Da1. Moreover, the inner peripheral surface 16c defining the diameter increasing portion 15c has a convex surface as a whole on the side close to the tool axis At, and has a surface shape corresponding to the shape of the inner peripheral surface of the hom. For this reason, in the present modification example as well, a vortex flow of the electrolytic solution is not substantially formed on the first side Da1 of the tool electrode 11c, and the plurality of bubbles B flow more smoothly than in the comparative example. Therefore, in the present modification example as well, the retention of the plurality of bubbles B between the tool electrode 11c and the workpiece W can be suppressed, and an increase in electric resistance between the tool electrode 11c and the workpiece W can be suppressed.

In a case where any of the inner angle θ formed by the first inner peripheral surface 161c and the second inner peripheral surface 162c and the inner angle formed by the second inner peripheral surface 162c and the third inner peripheral surface 163c is less than 135°, a vortex flow of the electrolytic solution is likely to be formed around the angle formed by the two inner peripheral surfaces. Therefore, it is preferable that each inner angle is 135° or more.

In addition, the shape of the inner peripheral surface 16c defining the diameter increasing portion 15c in the present modification example is a surface shape obtained by combining a part of outer peripheral surfaces of a plurality of cones having the second side Da2 as a vertex. However, the inner peripheral surface defining the diameter increasing portion may be a surface shape of a part of an outer peripheral surface of one cone having the second side Da2 as a vertex.

### Fourth Modification Example of Electrolysis Machining Tool

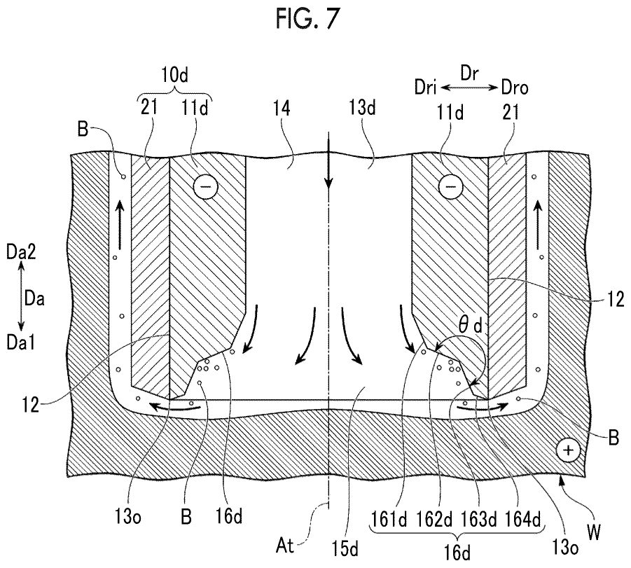

A fourth modification example of the electrolysis machining tool will be described with reference to FIG. 7.

As in the electrolysis machining tool 10 in the above-described embodiment, an electrolysis machining tool 10d in the present modification example also has a tool electrode 11d that is tubular around the tool axis At and of which the inner peripheral side forms an electrolytic solution passage 13d, and the insulation layer 21 that is formed on the electrode outer peripheral surface 12, which is the outer peripheral surface of the tubular tool electrode 11d.

As in the electrolytic solution passage 13 in the above-described embodiment, the electrolytic solution passage 13d in the present modification example also has the inlet, the outlet 13o, the main passage portion 14, and a diameter increasing portion 15d. However, the configuration of the diameter increasing portion 15d in the present modification example is different from the configuration of the diameter increasing portion 15 in the above-described embodiment.

An inner peripheral surface 16d of the tool electrode 11d defining the diameter increasing portion 15d in the present modification example has a first inner peripheral surface 161d, a second inner peripheral surface 162d, a third inner peripheral surface 163d, and a fourth inner peripheral surface 164d. All of the first inner peripheral surface 161d, the second inner peripheral surface 162d, the third inner peripheral surface 163d, and the fourth inner peripheral surface 164d have a surface shape corresponding to a part of an outer peripheral surface of a cone having the second side Da2 as a vertex and the first side Da1 as a bottom surface. The end of the first inner peripheral surface 161d on the second side Da2 is connected to the end of the main passage portion 14 on the first side Da1 in the electrolytic solution passage 13d. The end of the second outer peripheral surface on the second side Da2 is connected to the end of the first inner peripheral surface 161d on the first side Da1. The end of the third outer peripheral surface on the second side Da2 is connected to the end of the second inner peripheral surface 162d on the first side Da1. The end of the fourth inner peripheral surface 164d on the second side Da 2 is connected to the end of the third inner peripheral surface 163d on the first side Da1. The end of the fourth inner peripheral surface 164d on the first side Da1 is the outlet 13o. For this reason, the shape of the inner peripheral surface 16d defining the diameter increasing portion 15d in the cross section of the tool electrode 11d including the tool axis At is a shape in which four straight lines are connected to each other.

The diameter increasing rate of the second inner peripheral surface 162d is larger than the diameter increasing rate of the first inner peripheral surface 161d. In addition, the diameter increasing rate of the third inner peripheral surface 163d is smaller than the diameter increasing rate of the second inner peripheral surface 162d. The diameter increasing rate of the fourth inner peripheral surface 164d is larger than the diameter increasing rate of the third inner peripheral surface 163d.

As described above, as in the diameter increasing portions 15, 15a, 15b, 15c in the above-described embodiment and each of the above-described modification examples, the inner diameter of the diameter increasing portion 15d in the present modification example also gradually increases toward the first side Da1. In addition, in the cross section of the tool electrode 11d including the tool axis At, an inner angle formed by the first inner peripheral surface 161d and the second inner peripheral surface 162d, an inner angle Od formed by the second inner peripheral surface 162d and the third inner peripheral surface 163d, and an inner angle formed by the third inner peripheral surface 163d and the fourth inner peripheral surface 164d are all 135° or more.

For this reason, in the present modification example as well, as in the third modification example, the vortex flow of the electrolytic solution is not formed so much on the first side Da1 of the tool electrode 11d, and the plurality of bubbles B flow more smoothly than in the comparative example.

Therefore, in the present modification example as well, the retention of the plurality of bubbles B between the tool electrode 11d and the workpiece W can be suppressed, and an increase in electric resistance between the tool electrode 11d and the workpiece W can be suppressed.

However, in the present modification example, the diameter increasing rate of the third inner peripheral surface 163d is smaller than the diameter increasing rate of the second inner peripheral surface 162d, and the diameter increasing rate of the fourth inner peripheral surface 164d is larger than the diameter increasing rate of the third inner peripheral surface 163d. In other words, an inner angle Od formed by the second inner peripheral surface 162d and the third inner peripheral surface 163d is larger than 180°. Therefore, a part of the inner peripheral surface 16d of the tool electrode 11d defining the diameter increasing portion 15d in the present modification example is formed in a concave shape on a side away from the tool axis At. For this reason, in the present modification example, compared to the third modification example, a vortex flow of the electrolytic solution is more likely to be formed on the first side Da1 of the tool electrode 11d, and a plurality of bubbles B are more likely to stay between the tool electrode 11d and the workpiece W. Therefore, as in the above-described embodiment and each of the modification examples, it is preferable that the entire inner peripheral surface of the tool electrode defining the diameter increasing portion is a convex surface on the side close to the tool axis At.

In the present modification example, the shape of the inner peripheral surface 16d defining the diameter increasing portion 15d in the cross section of the tool electrode 11d including the tool axis At is a shape in which a plurality of straight lines are connected to each other. However, even when the shape of the inner peripheral surface defining the diameter increasing portion in the cross section of the tool electrode including the tool axis At is defined by one curved line, it is preferable that the entire inner peripheral surface defining the diameter increasing portion is a convex surface on the side close to the tool axis At.

### Fifth Modification Example of Electrolysis Machining Tool

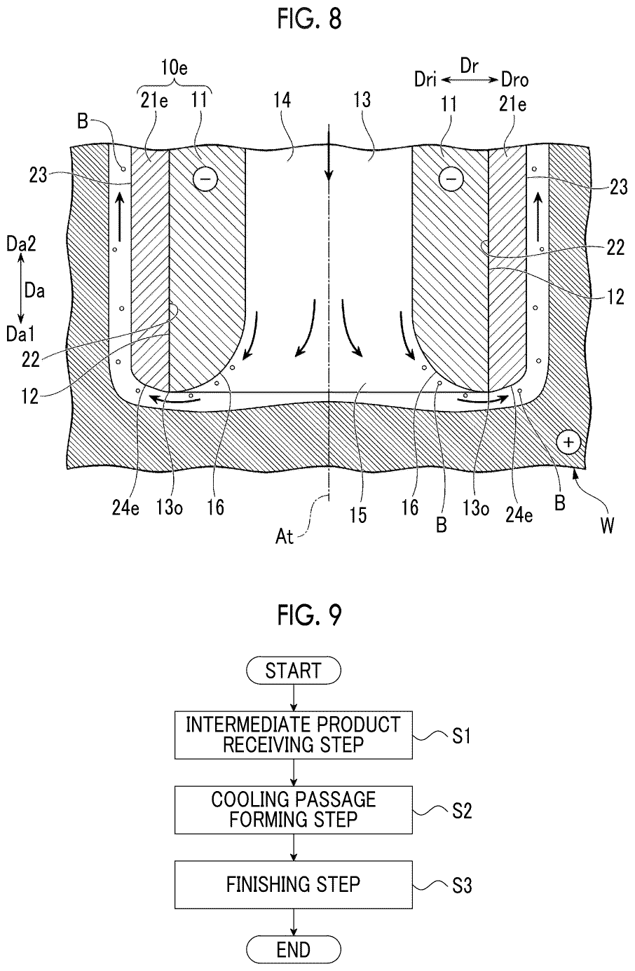

A fifth modification example of the electrolysis machining tool will be described with reference to FIG. 8.

As in the electrolysis machining tool 10 in the above-described embodiment, an electrolysis machining tool 10e in the present modification example also has the tool electrode 11 that is tubular around the tool axis At and of which the inner peripheral side forms the electrolytic solution passage 13, and an insulation layer 21e that is formed on the electrode outer peripheral surface 12, which is the outer peripheral surface of the tubular tool electrode 11. However, the configuration of the insulation layer 21e in the present modification example is different from the configuration of the insulation layer 21 in the above-described embodiment.

As in the insulation layer 21 in the above-described embodiment and each of the above-described modification examples, the insulation layer 21e in the present modification example also has the insulation layer inner peripheral surface 22, the insulation layer outer peripheral surface 23, and a first side insulation layer end surface 24e. As in the first side insulation layer end surface 24 in the above-described embodiment and each of the above-described modification examples, the first side insulation layer end surface 24e in the present modification example also gradually extends toward the second side Da2 as the first side insulation layer end surface 24e is directed toward the radial outer side Dro. However, the shape of the first side insulation layer end surface 24e in the cross section of the insulation layer 21e including the tool axis At is a curved surface that is convex toward the radial outer side Dro, which is different from the first side insulation layer end surface 24 in the above-described embodiment and each of the above-described modification examples. Therefore, in the present modification example, no angle is formed in a connecting portion between the end (outlet 13o) on the radial outer side Dro of the surface of the tool electrode 11 and the end on the radial inner side Dri of the first side insulation layer end surface 24e, and in a connecting portion between the end on the radial outer side Dro of the first side insulation layer end surface 24e and the end on the first side Da1 of the insulation layer outer peripheral surface 23.

In the present modification example, the electrolytic solution smoothly flows from the position along the surface of the tool electrode 11 to the position along the first side insulation layer end surface 24e. In addition, the electrolytic solution smoothly flows from the position along the first side insulation layer end surface 24e to the position along the insulation layer outer peripheral surface 23. For this reason, in the present modification example, it is possible to suppress the retention of the plurality of bubbles B between the tool electrode 11 and the workpiece W and to suppress an increase in electric resistance between the tool electrode 11 and the workpiece W, compared to the above-described embodiment and each of the above-described modification examples.

The present modification example is a modification example of the above-described embodiment. However, the insulation layer 21 in each of the above-described modification examples may also have the same shape as in the present modification example.

### Embodiment of Blade Manufacturing Method

An embodiment of a blade manufacturing method will be described with reference to FIGS. 9 to 13.

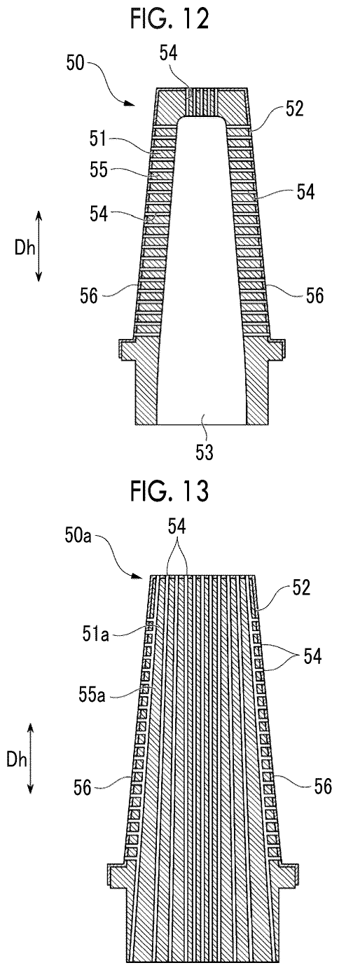

A blade manufactured in the present embodiment is a blade of a gas turbine. As shown in FIG. 12, a blade 50 has a blade body 51 of which a cross section has a blade shape and which extends in a blade height direction Dh perpendicular to the cross section. The blade body 51 has an outer surface 52, a blade passage 53, and a plurality of cooling passages 54. The blade passage 53 is formed inside the outer surface 52 of the blade body 51. The plurality of cooling passages 54 penetrate the outer surface 52 from the blade passage 53. In some cases, the blade 50 further includes a heat-shielding layer 56. The heat-shielding layer 56 is formed on the outer surface 52 of the blade body 51.

The blade 50 of the gas turbine is exposed to a high-temperature combustion gas. For this reason, cooling air is introduced into the blade passage 53, and the cooling air is ejected to the outside of the blade 50 through the plurality of cooling passages 54. The blade 50 is convection-cooled by cooling air flowing through the blade passage 53 and the plurality of cooling passages 54.

As shown in the flowchart of FIG. 9, the blade 50 is manufactured through an intermediate product receiving step S1, a cooling passage forming step S2, and a finishing step S3.

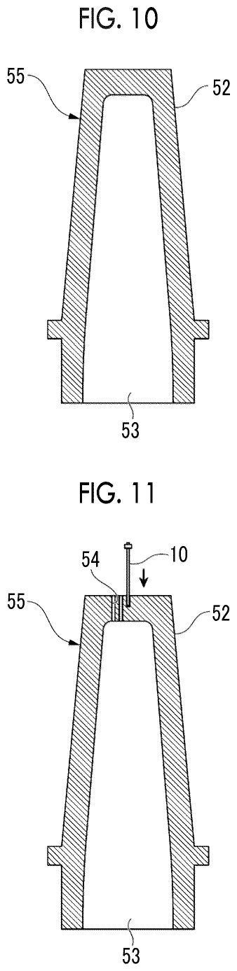

In the intermediate product receiving step S1, a blade intermediate product 55 in which the outer surface 52 of the target shape is received. The blade intermediate product 55 is, for example, cast using a mold. As shown in FIG. 10, the blade intermediate product 55 has the outer surface 52 and the blade passage 53, but does not have the cooling passage 54. In the intermediate product receiving step SI, an external party may form the blade intermediate product 55 and a final manufacturer of the blade may receive the blade intermediate product 55 from the external party. Alternatively, the final manufacturer of the blade may form the blade intermediate product 55 and the final manufacturer of the blade may receive the blade intermediate product 55.

In the cooling passage forming step S2, the cooling passage 54 is formed in the blade intermediate product 55 as shown in FIG. 11 by using the electrolysis machining device described above. In this case, in order to efficiently discharge bubbles generated in the electrolysis machining step, the orientation of the blade intermediate product 55 is adjusted such that an extending direction of the cooling passage 54 to be formed is a direction having a vertical component. Then, the electrolysis machining tool 10 of the electrolysis machining device is moved vertically downward with respect to the blade intermediate product 55 to form the cooling passage 54.

In the finishing step S3, the surface of the blade intermediate product 55 in which the cooling passages 54 are formed is polished, and in some cases, as shown in FIG. 12, a heat-shielding layer 56 is formed on the surface of the blade intermediate product 55 in which the cooling passages 54 are formed to perform a finishing treatment on the blade 50.

In the present embodiment, the cooling passage 54 is formed in the blade intermediate product 55 by using the electrolysis machining device described above. Therefore, the machining efficiency of the cooling passage 54 is improved, and the manufacturing cost of the blade 50 can be reduced.

The blade body 51 of the blade 50 has the outer surface 52, the blade passage 53, and the plurality of cooling passages 54. However, as shown in FIG. 13, a blade body 51a of a blade 50a may have the outer surface 52 and the plurality of cooling passages 54, and does not need to have the blade passage 53. In this case, a blade intermediate product 55a received in the intermediate product receiving step S1 has the outer surface 52, but does not have the blade passage 53. In addition, in this case, cooling air is introduced into the plurality of cooling passages 54, and the cooling air is ejected from the plurality of cooling passages 54 to the outside of the blade 50a.

In the blade 50 shown in FIG. 12, the plurality of cooling passages 54 are provided over all portions along the outer surface 52 of the blade body 51. In addition, in the blade 50a shown in FIG. 13, the plurality of cooling passages 54 are provided over the entire blade body 51a. However, only a part of the blade, for example, only a portion on one side in the blade height direction, may be provided with the plurality of cooling passages.

The present disclosure is not limited to the embodiments and each of the modification examples described above. Various additions, modifications, substitutions, partial deletions, and the like can be made without departing from the conceptual idea and gist of the present invention derived from the contents defined in the claims and equivalents thereof.

### Supplementary Notes

The electrolysis machining tools 10, 10a, 10b, 10c, 10d, 10e in the above-described embodiments and modification examples are understood as follows, for example.

(1) An electrolysis machining tool according to a first aspect includes:
the tool electrodes 11, 11a, 11b, 11c, 11d that are tubular around the tool axis At and of which the inner peripheral side forms the electrolytic solution passages 13, 13a, 13b, 13c, 13d; and the insulation layers 21, 21e that are formed on the electrode outer peripheral surface 12, which is the outer peripheral surface of the tubular tool electrodes 11, 11a, 11b, 11c, 11d. The electrolytic solution passages 13, 13a, 13b, 13c, 13d include the outlets 13o, 13ob formed at the end on the first side Da1, among the first side Da1 and the second side Da2 in the axial direction Da in which the tool axis At extends in the tool electrodes 11, 11a, 11b, 11c, 11d, and the diameter increasing portions 15, 15a, 15b, 15c, 15d in which the inner diameter gradually increases toward the first side Da1. The ends on the first side Da1 of the diameter increasing portions 15, 15a, 15b, 15c, 15d are the outlets 13o, 13ob.

During the electrolysis machining, the hydrogen ions or the water contained in the electrolytic solution receive electrons from the tool electrodes 11, 11a, 11b, 11c, 11d used as the cathode to form hydrogen bubbles B. The electrolytic solution passages 13, 13a, 13b, 13c, 13d according to the present aspect have the diameter increasing portions 15, 15a, 15b, 15c, 15d in which the inner diameters gradually increase toward the first side Da1, and the ends of the first side Da1 in the diameter increasing portions 15, 15a, 15b, 15c, 15d are outlets 13o, 13ob of the electrolytic solution passages 13, 13a, 13b, 13c, 13d. For this reason, in the present aspect, it is difficult for the vortex flow V of the electrolytic solution to be formed on the first side Da1 of the tool electrodes 11, 11a, 11b, 11c, 11d, and the plurality of bubbles B smoothly flow, and thus it is possible to suppress the retention of the plurality of bubbles B between the tool electrodes 11, 11a, 11b, 11c, 11d and the workpiece W. Therefore, in the present aspect, it is possible to suppress an increase in electric resistance between the tool electrodes 11, 11a, 11b, 11c, 11d and the workpiece W, and when the voltage applied between the tool electrodes 11, 11a, 11b, 11c, 11d and the workpiece W is increased, the value of the current flowing between the tool electrodes 11, 11a, 11b, 11c, 11d and the workpiece W also increases with an increase in the voltage, and thus the machining efficiency of the workpiece W can be improved.

(2) In an electrolysis machining tool according to a second aspect,
in the electrolysis machining tools 10, 10a, 10b, 10e according to the first aspect, the inner peripheral surfaces 16, 16a, 16b of the tool electrodes 11, 11a, 11b defining the diameter increasing portions 15, 15a, 15b of the electrolytic solution passages 13, 13a, 13b are smoothly continuous curved surfaces.

In the present aspect, the electrolytic solution and the bubbles B smoothly flow along the inner peripheral surfaces 16, 16a, 16b of the tool electrodes 11, 11a, 11b defining the diameter increasing portions 15, 15a, 15b of the electrolytic solution passages 13, 13a, 13b, and it is possible to suppress the retention of the plurality of bubbles B between the tool electrodes 11, 11a, 11b and the workpiece W.

(3) In an electrolysis machining tool according to a third aspect,
in the electrolysis machining tool 10c according to the first aspect, a shape of the inner peripheral surface 16c of the tool electrode 11c defining the diameter increasing portion 15c of the electrolytic solution passage 13c is a surface shape of a part of an inner peripheral surface of one cone having the second side Da2 as a vertex, or a surface shape obtained by combining a part of outer peripheral surfaces of the plurality of cones having the second side Da2 as a vertex.

(4) In an electrolysis machining tool according to a fourth aspect,
in the electrolysis machining tools 10, 10a, 10b, 10c, 10e according to any one of the first to third aspects, the inner peripheral surfaces 16, 16a, 16b, 16c of the tool electrodes 11, 11a, 11b, 11c defining the diameter increasing portions 15, 15a, 15b, 15c of the electrolytic solution passages 13, 13a, 13b, 13c have shapes corresponding to inner peripheral surfaces of horns.

In the present aspect, the electrolytic solution and the bubbles B smoothly flow along the inner peripheral surfaces 16, 16a, 16b, 16c defining the diameter increasing portions 15, 15a, 15b, 15c of the electrolytic solution passages 13, 13a, 13b, 13c, and it is possible to suppress the retention of the plurality of bubbles B between the tool electrodes 11, 11a, 11b, 11c and the workpiece W.

(5) In an electrolysis machining tool according to a fifth aspect,
in the electrolysis machining tools 10, 10a, 10b, 10c, 10e according to any one of the first to fourth aspects, the entire inner peripheral surfaces 16, 16a, 16b, 16c of the tool electrodes 11, 11a, 11b, 11c, 11d defining the diameter increasing portions 15, 15a, 15b, 15c are convex on a side close to the tool axis At.

In the present aspect, the retention of the bubbles B can be suppressed, compared to a case where a part of the inner peripheral surface of the tool electrode defining the diameter increasing portion is formed in a concave shape on a side away from the tool axis At.

(6) In an electrolysis machining tool according to a sixth aspect,
in the electrolysis machining tools 10, 10a, 10b, 10c, 10d, 10e according to any one of the first to fifth aspects, the insulation layers 21, 21e include the insulation layer outer peripheral surface 23 that is an outer peripheral surface of the insulation layers 21, 21e, and the first side insulation layer end surfaces 24, 24e that extend to the radial outer side Dro with respect to the tool axis At from the end on the first side Da1 of the electrode outer peripheral surface 12 to the end on the first side Da1 of the insulation layer outer peripheral surface 23. The first side insulation layer end surfaces 24, 24e gradually extend toward the second side Da2 as the first side insulation layer end surfaces 24, 24e are directed toward the radial outer side Dro.

Since the first side insulation layer end surfaces 24, 24e according to the present aspect gradually extend toward the second side Da2 as the first side insulation layer end surfaces 24, 24e are directed toward the radial outer side Dro, the bubbles B in the electrolytic solution flowing along the surfaces of the tool electrodes 11, 11a, 11b, 11c, 11d are likely to flow to the side of the insulation layer outer peripheral surface 23. Therefore, in the present aspect, from this viewpoint as well, the plurality of bubbles B smoothly flow, and it is possible to suppress the retention of the plurality of bubbles B between the tool electrodes 11, 11a, 11b, 11c, 11d and the workpiece W.

The electrolysis machining device in the above-described embodiment is understood as follows, for example.

(7) An electrolysis machining device according to a seventh aspect includes:
the electrolysis machining tools 10, 10a, 10b, 10c, 10d, 10e according to any one of the first to sixth aspects; a power supply circuit 1 configured to apply a voltage between the tool electrodes 11, 11a, 11b, 11c, 11d and the workpiece W such that the tool electrodes 11, 11a, 11b, 11c, 11d of the electrolysis machining tools 10, 10a, 10b, 10c, 10d, 10e are negative electrodes and the workpiece W to be machined by the electrolysis machining tools 10, 10a, 10b, 10c, 10d, 10e is a positive electrode; a movement mechanism 2 configured to relatively move the electrolysis machining tools 10, 10a, 10b, 10c, 10d, 10e with respect to the workpiece W; an electrolytic solution supply machine 3 configured to supply an electrolytic solution to the electrolytic solution passages 13, 13a, 13b, 13c, 13d; and a controller 4 configured to control the power supply circuit 1, the movement mechanism 2, and the electrolytic solution supply machine 3.

The electrolysis machining device according to the present aspect includes the electrolysis machining tools 10, 10a, 10b, 10c, 10d, 10e in any one of the first to fifth aspects described above. Therefore, it is possible to suppress the retention of the plurality of bubbles B between the tool electrodes 11, 11a, 11b, 11c, 11d and the workpiece W, and it is possible to improve the machining efficiency of the workpiece W.

The blade manufacturing method in the above-described embodiment is understood as follows, for example.

(8) A blade manufacturing method according to an eighth aspect executes:
the intermediate product receiving step SI of receiving the blade intermediate product 55 in which the outer surface 52 of the target shape is formed; and the cooling passage forming step S2 of forming the cooling passage 54 inside the blade intermediate product 55.

In the cooling passage forming step S2, the cooling passage 54 is formed in the blade intermediate product 55 by using the electrolysis machining device according to the seventh aspect.

In the blade manufacturing method according to the present aspect, the cooling passage 54 is formed in the blade intermediate product 55 by using the electrolysis machining device according to the seventh aspect. Therefore, the machining efficiency of the blade intermediate product 55 is improved, and the manufacturing cost of the blade 50 can be reduced.

### Industrial Applicability

According to one aspect of the present disclosure, it is possible to improve the machining efficiency of a workpiece.

### REFERENCE SIGNS LIST

1: power supply circuit
2: movement mechanism
3: electrolytic solution supply machine
3a: tank
3b: electrolytic solution line
3c: pump
4: controller
10, 10a, 10b, 10c, 10d, 10e, 10x: electrolysis machining tool
11, 11a, 11b, 11c, 11d, 11x: tool electrode
12, 12x: electrode outer peripheral surface
13, 13a, 13b, 13c, 13d, 13x: electrolytic solution passage
13i: inlet
13o, 13ob, 13ox: outlet
14: main passage portion
15, 15a, 15b, 15c, 15d: diameter increasing portion
16, 16a, 16b, 16c, 16d, 16x: inner peripheral surface
161c, 161d: first inner peripheral surface
162c, 162d: second inner peripheral surface
163c, 163d: third inner peripheral surface
164d: fourth inner peripheral surface
17b, 17x: first side electrode end surface
21, 21e, 21x: insulation layer
22, 22x: insulation layer inner peripheral surface
23, 23x: insulation layer outer peripheral surface
24, 24e, 24x: first side insulation layer end surface
50, 50a: blade
51, 51a: blade body
52: outer surface
53: blade passage
54: cooling passage
55, 55a: blade intermediate product
56: heat-shielding layer
At: tool axis
Da: axial direction
Da1: first side
Da2: second side
Dr: radial direction
Dri: radial inner side
Dro: radial outer side
B: bubble
V: vortex flow
W: workpiece

1. An electrolysis machining tool comprising:
a tool electrode that is tubular around a tool axis and of which an inner peripheral side forms an electrolytic solution passage; and
an insulation layer that is formed on an electrode outer peripheral surface, which is an outer peripheral surface of the tubular tool electrode,
wherein the electrolytic solution passage includes
an outlet formed at an end on a first side among the first side and a second side in an axial direction in which the tool axis extends in the tool electrode, and
a diameter increasing portion in which an inner diameter gradually increases toward the first side, and
an end on the first side of the diameter increasing portion is the outlet.

2. The electrolysis machining tool according to claim 1,
wherein an inner peripheral surface of the tool electrode defining the diameter increasing portion of the electrolytic solution passage is a smoothly continuous curved surface.

3. The electrolysis machining tool according to claim 1,
wherein an inner peripheral surface of the tool electrode defining the diameter increasing portion of the electrolytic solution passage is a surface of a part of an inner peripheral surface of one cone having the second side as a vertex, or a surface obtained by combining a part of outer peripheral surfaces of a plurality of cones having the second side as a vertex.

4. The electrolysis machining tool according to claim 1,
wherein an inner peripheral surface of the tool electrode defining the diameter increasing portion of the electrolytic solution passage has a shape corresponding to an inner peripheral surface of a horn.

5. The electrolysis machining tool according to claim 1,
wherein an entire inner peripheral surface of the tool electrode defining the diameter increasing portion is convex on a side close to the tool axis.

6. The electrolysis machining tool according to claim 1,
wherein the insulation layer includes an insulation layer outer peripheral surface that is an outer peripheral surface of the insulation layer, and a first side insulation layer end surface that extends to a radial outer side with respect to the tool axis from an end on the first side of the electrode outer peripheral surface to an end on the first side of the insulation layer outer peripheral surface, and
the first side insulation layer end surface gradually extends toward the second side as the first side insulation layer end surface is directed toward the radial outer side.

7. (canceled)

8. (canceled)
